(19) United States
(12) Patent Application Publication
(10) Pub. No.: US 2025/0356351 A1
(43) Pub. Date: Nov. 20, 2025

(54) SYSTEMS AND METHODS FOR TRANSACTION VERIFICATION BY TAP

(71) Applicant: JPMORGAN CHASE BANK, N.A., New York, NY (US)

(72) Inventors: Gerardo GEAN, Plano, TX (US); Sandeep Reddy BANALA, Monroe, NJ (US); Goran LONCARIC, Frisco, TX (US); Raghu VUDATHU, Downingtown, PA (US); Maurice SHORROSH, Edgewater, NJ (US)

(21) Appl. No.: 19/208,373

(22) Filed: May 14, 2025

Related U.S. Application Data
(60) Provisional application No. 63/647,306, filed on May 14, 2024.
(60) Provisional application No. 63/651,766, filed on May 24, 2024.

(51) Int. Cl. G06Q 20/40; G06Q 20/32; G06Q 20/34

(52) U.S. Cl. CPC G06Q 20/401; G06Q 20/3278; G06Q 20/352

(57) ABSTRACT

Systems and methods for verification by tap are disclosed. In one embodiment, a method may include: receiving, by a computer program executed by an electronic device and from a mobile application executed by a mobile electronic device, an action selected by a user; determining, by the computer program, that the action is a sensitive action; causing, by the computer program, the mobile application to display an instruction to present a wireless-enabled device to the mobile electronic device; receiving, by the computer program and from the mobile application, device information that was received wirelessly from the wireless-enabled device; validating, by the computer program, the device information; and executing, by the computer program, the sensitive action in response to the device information being validated.

### RELATED APPLICATIONS

This application claims priority to, and the benefit of, U.S. Provisional Patent Application Ser. No. 63/647,306, filed May 14, 2024, and U.S. Provisional Patent Application Ser. No. 63/651,766, filed May 24, 2024, the disclosure of each of which is hereby incorporated, by reference, in its entirety.

### BACKGROUND OF THE INVENTION

### 1. Field of the Invention

Embodiments relate to systems and methods for verification by tap.

### 2. Description of the Related Art

As fraud tactics advance, it is important for financial institutions to adopt authentication credentials that blend robust security with user-friendly methods, lessening reliance on one-time passcodes and similar.

### SUMMARY OF THE INVENTION

Systems and methods for verification by tap are disclosed. In one embodiment, a method may include: receiving, by a computer program executed by an electronic device and from a mobile application executed by a mobile electronic device, an action selected by a user; determining, by the computer program, that the action is a sensitive action; causing, by the computer program, the mobile application to display an instruction to present a wireless-enabled device to the mobile electronic device; receiving, by the computer program and from the mobile application, device information that was received wirelessly from the wireless-enabled device; validating, by the computer program, the device information; and executing, by the computer program, the sensitive action in response to the device information being validated.

In one embodiment, the action may be determined to be the sensitive action based on a time of day and/or a location of the mobile electronic device.

In one embodiment, the action may be determined to be the sensitive action based on a type of action.

In one embodiment, the wireless-enabled device may include a wireless-enabled financial instrument, and the device information may include information stored by a chip on the wireless-enabled financial instrument.

In one embodiment, the device information may be received by near field communication.

In one embodiment, the method may also include receiving, by the computer program, a timestamp with the device information.

In one embodiment, the method may also include communicating, by the computer program, a notification to the mobile application that the action was executed.

According to another embodiment, a method may include: receiving, by a mobile application executed by a mobile electronic device, a selection of an action to execute; communicating, by the mobile application, the action to a backend computer program executed by a backend electronic device; receiving, by the mobile application and from the backend computer program, a notification to display an instruction to present a wireless-enabled device to the mobile electronic device; displaying, by the mobile application, the instruction; wirelessly receiving, by the mobile application, device information from a wireless-enabled device; communicating, by the mobile application, the device information to the backend computer program; and receiving, by the mobile application, a notification from the backend computer program based on execution of the action.

In one embodiment, the backend computer program may be configured to determine that the action is a sensitive action.

In one embodiment, the action may be determined to be the sensitive action based on a time of day and/or a location of the mobile electronic device.

In one embodiment, the action may be determined to be the sensitive action based on a type of action.

In one embodiment, the wireless-enabled device may include a wireless-enabled financial instrument, and the device information may include information stored by a chip on the wireless-enabled financial instrument.

In one embodiment, the method may also include communicating, by the mobile application and to the backend computer program, a timestamp with the device information.

In one embodiment, the device information may be received by near field communication.

According to another embodiment, a system may include: a mobile electronic device executing a mobile application; and a backend computer program executed by a backend electronic device. The mobile application is configured to receive a selection of an action to execute and to communicate the action to the backend computer program; the backend computer program is configured to determine that the action is a sensitive action; the backend computer program is configured to send a notification to the mobile application to display an instruction to present a wireless-enabled device to the mobile electronic device; the mobile application is configured to present the instruction; the mobile application is configured to wirelessly receive device information from a wireless-enabled device and to communicate the device information to the backend computer program; the backend computer program is configured to validate the device information; and the backend computer program is configured to execute the sensitive action in response to the device information being validated.

In one embodiment, the action may be determined to be the sensitive action based on a time of day and/or a location of the mobile electronic device.

In one embodiment, the action may be determined to be the sensitive action based on a type of action.

In one embodiment, the wireless-enabled device may include a wireless-enabled financial instrument, and the device information may include information stored by a chip on the wireless-enabled financial instrument.

In one embodiment, the mobile application may be configured to communicate a timestamp with the device information to the backend computer program.

In one embodiment, the device information may be received by near field communication.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for verification by tap according to an embodiment;

FIGS. 2A and 2B illustrate a method for verification by tap according to an embodiment;

FIG. 3 depicts an exemplary computing system for implementing aspects of the present disclosure.

### DETAILED DESCRIPTION OF PREFERRED EMBODIMENTS

Embodiments relate to systems and methods for verification by tap.

Embodiments not only combat fraud but also streamline the verification process for customers, ensuring a swift, secure, and intuitive experience.

In embodiments, during the course of a transaction, a cardholder may be requested to present (or “tap”) a physical device (e.g., a credit card, a debit card, etc.) to a trusted electronic device in order to conduct a transaction. For example, a cardholder may present a physical credit card to a point-of-sale device in order as payment for a transaction. As part of its approval process, the issuing financial institution may require that the cardholder log in to the issuing financial institution's mobile application, and present the physical credit card to the mobile electronic device, in order to confirm that the transaction is not fraudulent.

In one embodiment, other physical devices, such as NFC-enabled identification cards, such as driver's licenses, may be presented as well. The cardholder may register these other physical devices with the issuing financial institution.

Alternatively, the issuing financial institution may require the cardholder to log in to the mobile application, and confirm the transaction by using biometric authentication or similar. In one embodiment, the cardholder may perform this authentication with a virtual card, such as a credit card that has been provisioned to a third-party electronic wallet application by tapping the physical credit card to the mobile electronic device. The issuing financial institution may receive an indication of such provisioning from the third-party electronic wallet application, and the biometric authentication or other confirmation may involve “presenting” the virtual card for the physical credit card with biometric authentication.

In one embodiment, the presentation may be required for transactions that are identified as having a risk above a certain threshold (e.g., high value, outside of a certain geographic area, etc.).

In another embodiment, the cardholder may be required to present, or tap, the physical card to the mobile electronic device to verify a transaction or account-related activity. For example, the cardholder may request a person-to-person payment using, for example, the issuer mobile application, a service provided by the issuer mobile application, etc. Example of such services may include ZELLE, wire transfers, money transfers, etc. The issuing financial institution may require that the cardholder present (or tap) a physical card issued by the issuing financial institution to the mobile electronic device to confirm the transaction, or to confirm using the virtual card with biometric authentication as described above, before the payment is allowed to proceed.

In one embodiment, the recipient of the person-to-person payment may be required to perform a similar verification by tapping or presenting a virtual card as described above before the payment is released to the recipient.

Other activities, including changing the cardholder's address, changing the cardholder's phone number, changing the cardholder's email address, changing the cardholder's password or requesting password recovery, changing the cardholder's personal identification number, adding an authorized user to a card, etc. may also require such verification. The cardholder may be requested to present the physical card when interacting with an agent of the issuing financial institution, with an interactive voice response system, etc.

In one embodiment, the cardholder may present a physical card to the mobile application before an in-person visit. The cardholder may also pre-stage an interaction using the mobile application.

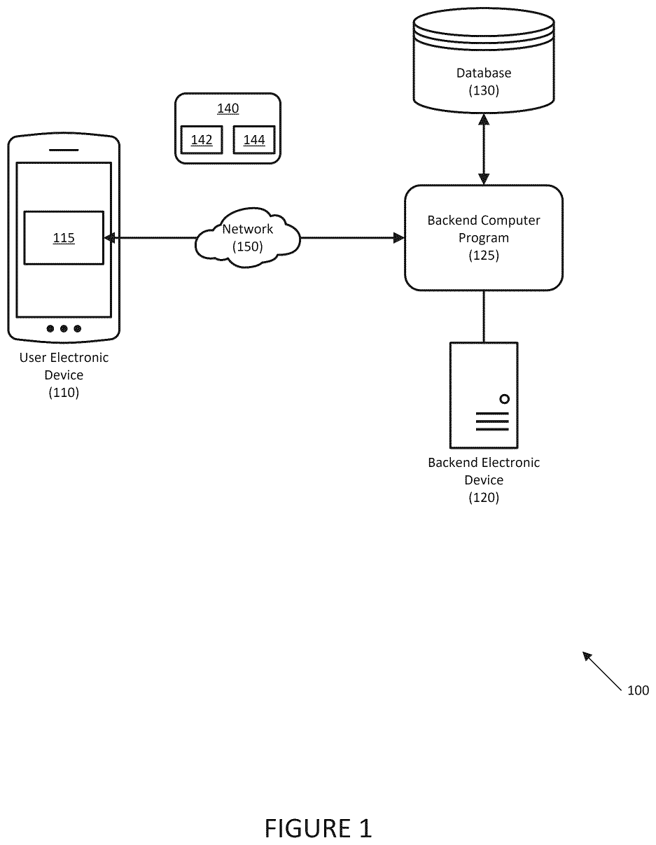

Referring to FIG. 1, a system for verification by tap is disclosed according to an embodiment. System 100 may include user electronic device 110, which may be mobile electronic device (e.g., notebook computer, laptop computer, tablet computer, smart phone, smart watch, Internet of Things appliance, etc.) User electronic device 110 may execute application 115, such as an application provided by a backend for an institution (e.g., a financial institution).

User electronic device 110 may be a wireless-enabled device, and may communicate via Near Field Communication (NFC), Bluetooth, Bluetooth Low Energy, etc. For example, user electronic device 110 may read information from physical device 140, which may be a wirelessly enabled device that may include chip or memory 142 that stores information, and may communicate that information by NFC, Bluetooth, etc. using antenna 144.

In one embodiment, physical device 140 may be a credit card, a debit card, a driver's license, or other identification, etc. and the information may include an account information (e.g., account number, expiration data, etc.) or any other information that may be stored in chip or memory 142.

In another embodiment, chip information, such as a serial number or other chip identifier, may be read.

Application 115 may communicate with backend computer program 125 via network 150, which may be any suitable network, including the Internet.

Backend electronic device 120 may be a server (e.g., physical and/or cloud-based), a computer (e.g., workstation, desktop, laptop, notebook, tablet, etc.), etc. Backend electronic device 120 may execute backend computer program 125, which may receive information from application 115, may verify the information, and may execute a feature selected by the user.

In one embodiment, backend computer program 125 may retrieve verification information from database 130 to verify information received from application 115.

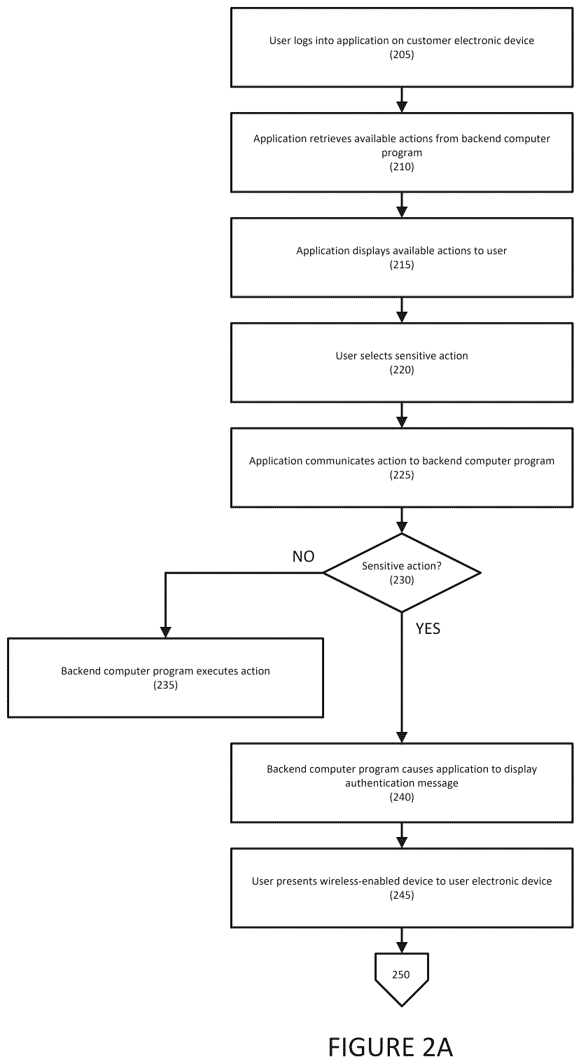

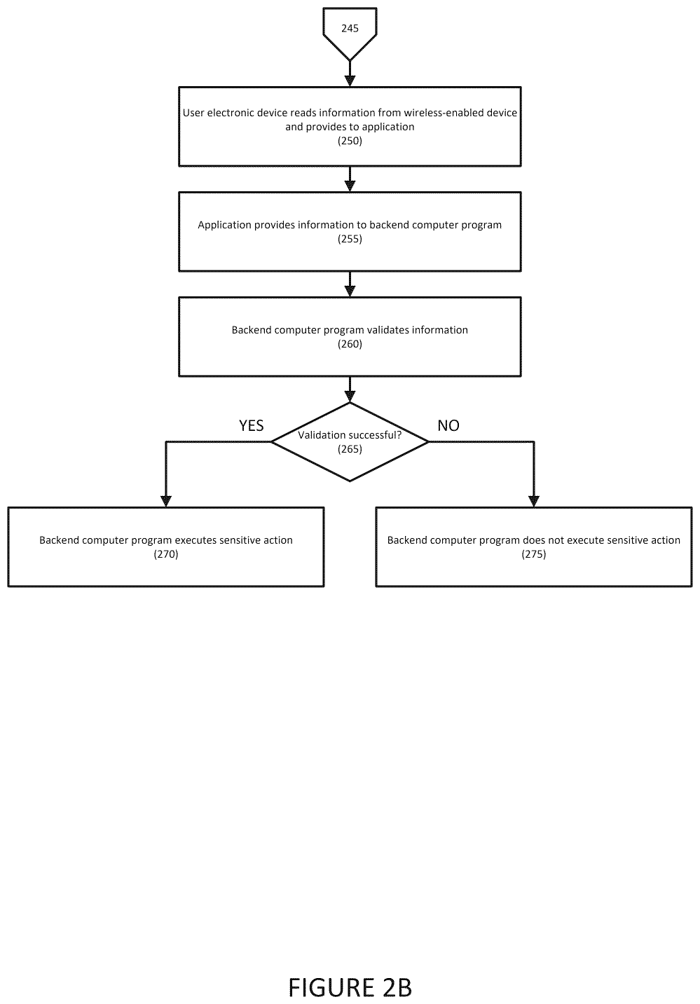

Referring to FIGS. 2A and 2B, a method for verification by tap is disclosed according to an embodiment.

In step 205, a user may log into an application that is executed on a customer electronic device. The application may be provided by an institution, such as a financial institution.

In one embodiment, the user may be directed to the application from another application executed by the user electronic device. For example, the user may be on a phone call with a customer service agent, and the customer service agent may request that the user present a physical card to the user electronic device for authentication.

In step 210, if necessary, once authenticated, the application may retrieve available actions for the user to take from backend computer program. The actions that re retrieved may be based on the type of user accounts, the user location (e.g., certain actions may not be available if the user is outside of a registered “safe space,” if it is a certain time of day (e.g., to reduce fraud, certain features may not be available between midnight and 4 AM), etc.

A description of “safe spaces” and the use thereof is provided in U.S. Provisional Patent Application Ser. No. 63/514,847 and U.S. patent application Ser. No. 18/778,473, the disclosures of each of which is hereby incorporated, by reference, in its entirety.

Certain actions may be considered to be sensitive actions, and may require additional authentication. Examples may include non-recoverable person-to-person payments, wire transfers, money transfers, etc. In one embodiment, only transactions above a certain amount may be considered to be sensitive.

Examples of other sensitive actions may include changing the user's address, changing the user's phone number, changing the user's email address, changing the user's password or requesting password recovery, changing the user's personal identification number, adding an authorized user to a card, etc.

Other types of sensitive actions may be included as is necessary and/or desired.

In step 215, the application may display the available actions to user.

In step 220, the user may select an action.

In step 225, the application may communicate the action to a backend computer program, and in step 230, the backend computer program determines whether the action is a sensitive action. In one embodiment, the backend computer program may determine whether the action is a sensitive action based on the type of action, a threshold involved in the action, a location of the user (e.g., whether the user is in a safe space or a known location), whether the user electronic device is a registered or known user electronic device, etc.

If the action is not a sensitive action, in step 235, the backend computer program may execute the action.

If the action is a sensitive action, in step 240, the backend computer program may cause the application to display an authentication message. An example of an authentication message is “Please tap your credit card ending in 1234 to your mobile device.”

In step 245, the user may present the requested wireless-enabled device to the user electronic device, and in step 250, the user electronic device may read device information from wireless-enabled device and may provide the information to the application.

The device information may be account information, a chip identifier, or any other information that may be stored on the wireless-enabled device.

In step 255, the application may provide the device information to the backend computer program. In one embodiment, the application may provide additional information, such as a timestamp for when the device information was read, to confirm that the device information is not stored device information.

In step 260, the backend computer program may validate the device information. For example, the backend computer program may retrieve validation device information (i.e., stored device information that can be used to validate the device information received from the application) from a database, and may compare the validation device information to the information received from the application.

If, in step 265, the validation was successful, in step 270, the backend computer program may execute the sensitive action. The backend computer program may send a confirmation to the application.

In one embodiment, the backend computer program or the application may inform another application or entity (e.g., a customer service agent) that the authentication was successful.

If, in step 265, the validation was not successful, in step 275, the backend computer program may not execute the sensitive action. The backend computer program may send a message to the application indicating that the action was not executed.

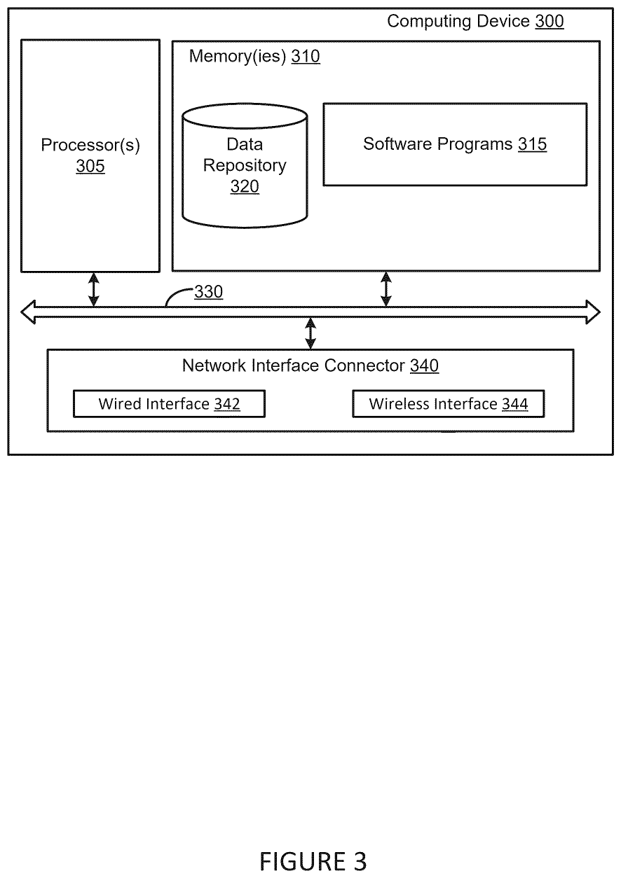

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a computer program executed by an electronic device and from a mobile application executed by a mobile electronic device, an action selected by a user;
determining, by the computer program, that the action is a sensitive action;
causing, by the computer program, the mobile application to display an instruction to present a wireless-enabled device to the mobile electronic device;
receiving, by the computer program and from the mobile application, device information that was received wirelessly from the wireless-enabled device;
validating, by the computer program, the device information; and
executing, by the computer program, the sensitive action in response to the device information being validated.

2. The method of claim 1, wherein the action is determined to be the sensitive action based on a time of day and/or a location of the mobile electronic device.

3. The method of claim 1, wherein the action is determined to be the sensitive action based on a type of action.

4. The method of claim 1, wherein the wireless-enabled device comprises a wireless-enabled financial instrument, and the device information comprises information stored by a chip on the wireless-enabled financial instrument.

5. The method of claim 1, wherein the device information is received by near field communication.

6. The method of claim 1, further comprising:
receiving, by the computer program, a timestamp with the device information.

7. The method of claim 1, further comprising:
communicating, by the computer program, a notification to the mobile application that the action was executed.

8. A method, comprising:
receiving, by a mobile application executed by a mobile electronic device, a selection of an action to execute;
communicating, by the mobile application, the action to a backend computer program executed by a backend electronic device;
receiving, by the mobile application and from the backend computer program, a notification to display an instruction to present a wireless-enabled device to the mobile electronic device;
displaying, by the mobile application, the instruction;
wirelessly receiving, by the mobile application, device information from a wireless-enabled device;
communicating, by the mobile application, the device information to the backend computer program; and
receiving, by the mobile application, a notification from the backend computer program based on execution of the action.

9. The method of claim 8, wherein the backend computer program is configured to determine that the action is a sensitive action.

10. The method of claim 9, wherein the action is determined to be the sensitive action based on a time of day and/or a location of the mobile electronic device.

11. The method of claim 9, wherein the action is determined to be the sensitive action based on a type of action.

12. The method of claim 8, wherein the wireless-enabled device comprises a wireless-enabled financial instrument, and the device information comprises information stored by a chip on the wireless-enabled financial instrument.

13. The method of claim 8, further comprising:
communicating, by the mobile application and to the backend computer program, a timestamp with the device information.

14. The method of claim 8, wherein the device information is received by near field communication.

15. A system, comprising:
a mobile electronic device executing a mobile application; and
a backend computer program executed by a backend electronic device;
wherein:
the mobile application is configured to receive a selection of an action to execute and to communicate the action to the backend computer program;
the backend computer program is configured to determine that the action is a sensitive action;
the backend computer program is configured to send a notification to the mobile application to display an instruction to present a wireless-enabled device to the mobile electronic device;
the mobile application is configured to present the instruction;
the mobile application is configured to wirelessly receive device information from a wireless-enabled device and to communicate the device information to the backend computer program;
the backend computer program is configured to validate the device information; and
the backend computer program is configured to execute the sensitive action in response to the device information being validated.

16. The system of claim 15, wherein the action is determined to be the sensitive action based on a time of day and/or a location of the mobile electronic device.

17. The system of claim 15, wherein the action is determined to be the sensitive action based on a type of action.

18. The system of claim 15, wherein the wireless-enabled device comprises a wireless-enabled financial instrument, and the device information comprises information stored by a chip on the wireless-enabled financial instrument.

19. The system of claim 15, wherein the mobile application is configured to communicate a timestamp with the device information to the backend computer program.

20. The system of claim 15, wherein the device information is received by near field communication.
